(19) United States
(12) Patent Application Publication
(10) Pub. No.: US 2005/0055253 A1
(43) Pub. Date: Mar. 10, 2005

(54) Mechanism for tracking product development through multiple milestones

(76) Inventors: Sujay Sahni, Sammamish, WA (US); Feroze B. Daud, Snoqualmie, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(21) Appl. No.: 10/655,434

(22) Filed: Sep. 4, 2003

(51) Int. Cl. G06F 17/60

(52) U.S. Cl. 705/7

(57) ABSTRACT

Software that enables computing systems to display product development progress in a manner that allows development progress with respect to multiple development milestones to be simultaneously viewed. For each milestone, the computing system maps each of range of development progress levels to a corresponding discrete performance grade. The development progress levels may also be mapped for each of a number of different teams, and for each of a number of different performance factors related to the product development. The computing system then measures the development progress at a particular point in time, and then identifies a discrete performance grade for each of at least some (and potentially all) of the milestones. For each milestone (and potentially for each team and performance factor), the computing system displays an indication of the identified performance grade in a different manner depending on the identified performance grade.

### BACKGROUND OF THE INVENTION

1. The Field of the Invention

The present invention relates to software-aided product development progress tracking. More specifically, the present invention relates to software that enables such development progress to be tracked through several milestones in which progress with respect to several milestones is simultaneously displayed to thereby allow a user to gain an advanced understanding as to how progress is being made with respect to not only the next milestone, but with respect to other subsequent milestones as well.

2. Background and Related Art

Our consumer-oriented market society rewards companies and individuals that develop products that are innovative, high-quality and timely in the marketplace. On the other hand, companies that miss important market timing windows, or which develop lower quality products even in a timely manner, tend to do less well. With technology ever advancing at astonishing rates, it is critical that high-quality products be developed in a timely manner.

With this in mind, product development tracking software has been introduced. In more complex products, product development may take some time and may best be tracked when broken down into several milestones culminating in a final milestone that represents the release of the product. Conventional software tracking software allows managers or other interested and authorized parties to measure and visually track how development is going with respect to particular milestones. However, it is more difficult to obtain an overall feel of the health of product development. For example, perhaps the product is being developed on schedule with respect to the next milestone, but is falling behind with respect to the release of the product.

Such a condition may be quite common for example, when various teams are working on several components of the product, which are ultimately integrated into one product close to the final release. If one team is on schedule, and the other is falling behind, a manager may be lulled into false senses of security when evaluating the impact of the team being on schedule. Such a false sense of security may induce the manager into delaying corrective action. Furthermore, even in products that are not integrated from various components developed by separate teams, there may be other unique finalization processes that result in the final milestone being difficult to reach on schedule even if the previous milestones were on or ahead of schedule.

Typical product development tracking software focuses on a per milestone view of how things are going with product development. As previously mentioned, this could result in misplaced senses of security, and delay in corrective action with respect to subsequent milestones. Accordingly, what would be advantageous is product development tracking software that provided not only tracking with respect to a particular milestone, but also provided a more comprehensive picture of the overall health of product development across all milestones.

### BRIEF SUMMARY OF THE INVENTION

The foregoing problems with the prior state of the art are overcome by the principles of the present invention, which is directed towards software that enables computing systems to render product development progress on a display in a manner that allows development progress with respect to multiple development milestones to be simultaneously viewed. Accordingly, a user may gain cognizance of not only the product development progress with respect to the next milestone, but also with respect to subsequent milestones as well, including the product release milestone. Accordingly, the user is given a better overall view of the health of the product development.

For each milestone, the computing system maps each of range of development progress levels to a corresponding discrete performance grade. The development progress levels may also be mapped for each of a number of different teams, and for each of a number of different performance factors related to the product development. The mapping may be in, for example, a performance grade definition table.

The computing system then measures the development progress at a particular point in time, and then identifies a discrete performance grade for each of at least some (and potentially all) of the milestones. This may be done for each milestone, for each team, and for each performance factor. Alternatively, the measure performance progress represents a combination of a number of performance factors. The various measured performances for the various milestones, teams, and performance factors may be represented in a table called a measurement table. The corresponding grade for each milestone, team and performance factor may be represented in a table called the performance grade table.

For each milestone (and potentially for each team and performance factor), the computing system displays an indication of the identified performance grade. The manner of display differs depending on the identified performance grade. For example, the computing system may simple display a human-readable form of the performance grade, or may display an icon having a particular color that represents a certain grade.

In this manner, the user may view the performance grades for a number of different milestones simultaneously thereby giving the user an overall view of the health of product development. This gives the user, sooner rather than later, a better intuitive feeling as to whether corrective action needs to be taken. Accordingly, the release of the product is more likely to be on schedule without sacrificing quality since corrective action is more likely to be taken sooner.

The principles of the present invention also allow a team representative or manager (or other user) to change the mapping of specific development progress levels to specific performance grades. For example, perhaps one team is seriously understaffed and is in the process of hiring a number of new employees. The mapping may be made more lenient for that team to compensate for the team being understaffed currently. Users may, subject to security policies, set the mapping universally (e.g., for all milestones, teams, or performance factors), or instead set specific unique mappings for each specific combination of milestones, teams, and performance factors, thereby giving fine-grained control over the mapping of specific development progress levels to specific performance grades.

Additional features and advantages of the invention will be set forth in the description that follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a suitable computing system that may implement the features of the present invention;

FIG. 2 illustrates a flowchart of a method for rendering product development progress on a display in a manner that allows development progress with respect to multiple development miles to be simultaneously viewed;

FIG. 3 illustrates an example performance grade definition table for use in performing the method of FIG. 2;

FIG. 4 illustrates an example measurement table for use in performing the method of FIG. 2; and

FIG. 5 illustrates an example performance grade table for use in performing the method of FIG. 2.

### DETAILED DESCRIPTION OF THE PREFERRED EMBODIMENTS

The principles of the present invention relate to software that enables computing systems to render product development progress on a display in a manner that allows development progress with respect to multiple development milestones to be simultaneously viewed. For each milestone, the computing system maps each of range of development progress levels to a corresponding discrete performance grade. The development progress levels may also be mapped for each of a number of different teams, and for each of a number of different performance factors related to the product development. The computing system then measures the development progress at a particular point in time, and then identifies a discrete performance grade for each of at least some (and potentially all) of the milestones. This may be done for each milestone, for each team, and for each performance factor.

For each milestone (and potentially for each team and performance factor), the computing system displays an indication of the identified performance grade. The manner of display differs depending on the identified performance grade. In this manner, the user may view the performance grades for a number of different milestones simultaneously thereby giving the user an overall view of the health of product development.

Embodiments within the scope of the present invention include computer-readable media for carrying or having computer-executable instructions or data structures stored thereon. Such computer-readable media can be any available media which can be accessed by a general purpose or special purpose computer. By way of example, and not limitation, such computer-readable media can comprise physical computer-readable media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer.

When information is transferred or provided over a network or another communications connection (either hardwired, wireless, or a combination of hardwired or wireless) to a computer, the computer properly views the connection as a computer-readable medium. Thus, any such a connection is properly termed a computer-readable medium. Combinations of the above should also be included within the scope of computer-readable media. Computer-executable instructions comprise, for example, any instructions and data which cause a general purpose computer, special purpose computer, or special purpose processing device to perform a certain function or group of functions. The computer-executable instruction may be, for example, binaries, intermediate format instructions such as assembly language, or even source code. Although not required, the invention will be described in the general context of computer-executable instructions, such as program modules, being executed by computers in network environments. Generally, program modules include routines, programs, objects, components, data structures, etc. that perform particular tasks or implement particular abstract data types.

Those skilled in the art will appreciate that the invention may be practiced in network computing environments with many types of computing system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

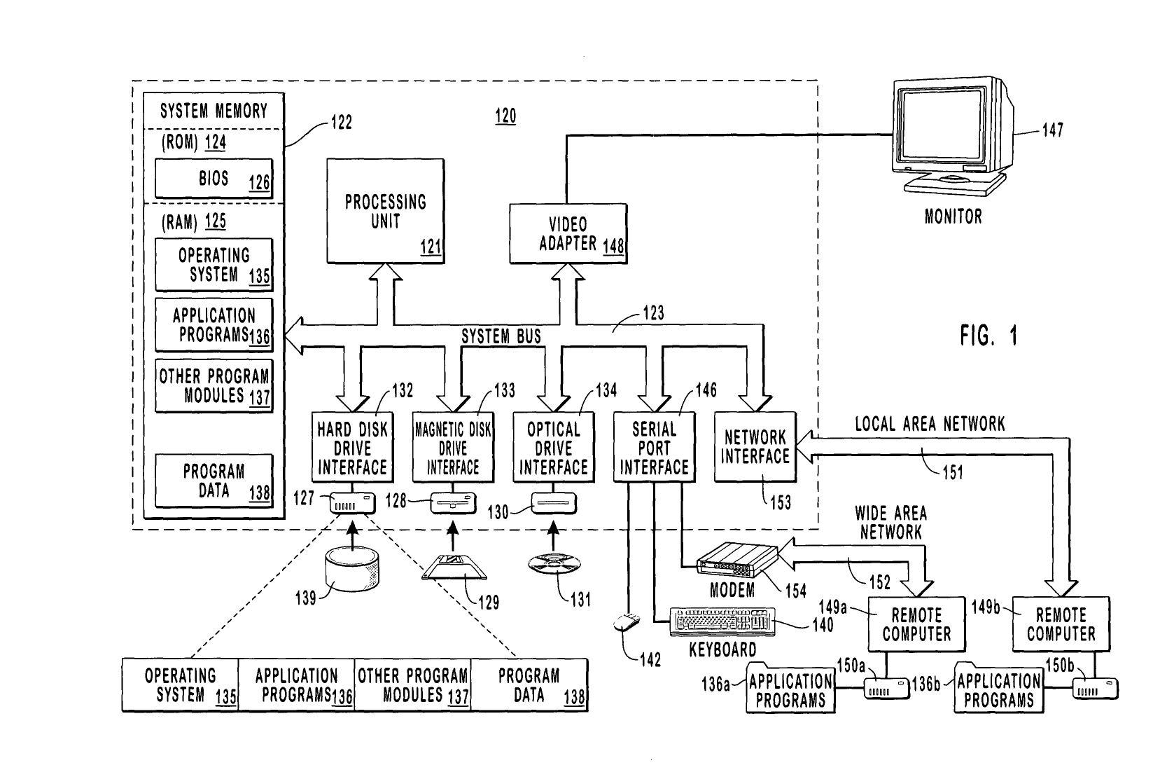

FIG. 1 illustrates suitable computing environment in which the principles of the present invention may be employed in the form of a computer 120. The computer 120 includes a processing unit 121, a system memory 122, and a system bus 123 that couples various system components including the system memory 122 to the processing unit 121.

The system bus 123 may be any of several types of bus structures including a memory bus or memory controller, a peripheral bus, and a local bus using any of a variety of bus architectures. The system memory includes read only memory (ROM) 124 and random access memory (RAM) 125. A basic input/output system (BIOS) 126, containing the basic routines that help transfer information between elements within the computer 120, such as during start-up, may be stored in ROM 124.

The computer 120 may also include a magnetic hard disk drive 127 for reading from and writing to a magnetic hard disk 139, a magnetic disk drive 128 for reading from or writing to a removable magnetic disk 129, and an optical disk drive 130 for reading from or writing to removable optical disk 131 such as a CD-ROM or other optical media. The magnetic hard disk drive 127, magnetic disk drive 128, and optical disk drive 130 are connected to the system bus 123 by a hard disk drive interface 132, a magnetic disk drive-interface 133, and an optical drive interface 134, respectively. The drives and their associated computer-readable media provide nonvolatile storage of computer-executable instructions, data structures, program modules and other data for the computer 120. Although the exemplary environment described herein employs a magnetic hard disk 139, a removable magnetic disk 129 and a removable optical disk 131, other types of computer readable media for storing data can be used, including magnetic cassettes, flash memory cards, digital video disks, Bernoulli cartridges, RAMs, ROMs, and the like.

Program code means comprising one or more program modules may be stored on the hard disk 139, magnetic disk 129, optical disk 131, ROM 124 or RAM 125, including an operating system 135, one or more application programs 136, other program modules 137, and program data 138. A user may enter commands and information into the computer 120 through keyboard 140, pointing device 142, or other input devices (not shown), such as a microphone, joy stick, game pad, satellite dish, scanner, or the like. These and other input devices are often connected to the processing unit 121 through a serial port interface 146 coupled to system bus 123. Alternatively, the input devices may be connected by other interfaces, such as a parallel port, a game port or a universal serial bus (USB). A monitor 147 or another display device is also connected to system bus 123 via an interface, such as video adapter 148. In addition to the monitor, personal computers typically include other peripheral output devices (not shown), such as speakers and printers.

The computer 120 may operate in a networked environment using logical connections to one or more remote computers, such as remote computers 149a and 149b. Remote computers 149a and 149b may each be another personal computer, a server, a router, a network PC, a peer device or other common network node, and typically include many or all of the elements described above relative to the computer 120, although only memory storage devices 150a and 150b and their associated application programs 136a and 136b have been illustrated in FIG. 1. The logical connections depicted in FIG. 1 include a local area network (LAN) 151 and a wide area network (WAN) 152 that are presented here by way of example and not limitation. Such networking environments are commonplace in office-wide or enterprise-wide computer networks, intranets and the Internet.

When used in a LAN networking environment, the computer 120 is connected to the local network 151 through a network interface or adapter 153. When used in a WAN networking environment, the computer 120 may include a modem 154, a wireless link, or other means for establishing communications over the wide area network 152, such as the Internet. The modem 154, which may be internal or external, is connected to the system bus 123 via the serial port interface 146. In a networked environment, program modules depicted relative to the computer 120, or portions thereof, may be stored in the remote memory storage device. It will be appreciated that the network connections shown are exemplary and other means of establishing communications over wide area network 152 may be used.

While FIG. 1 represents a suitable operating environment for the present invention, the principles of the present invention may be employed in any computing system that is capable of processing information and rendering information on a display. The computing system illustrated in FIG. 1 is illustrative only, and by no means represents even a small portion of the wide variety of environments in which the principles of the present invention may be implemented. In the description and in the claims, a “computing system” is defined broadly as any hardware component or components that are capable of using software to perform one or more functions. Examples of computing systems include desktop computers, laptop computers, Personal Digital Assistants (PDAs), telephones, or any other system or device that has processing capability.

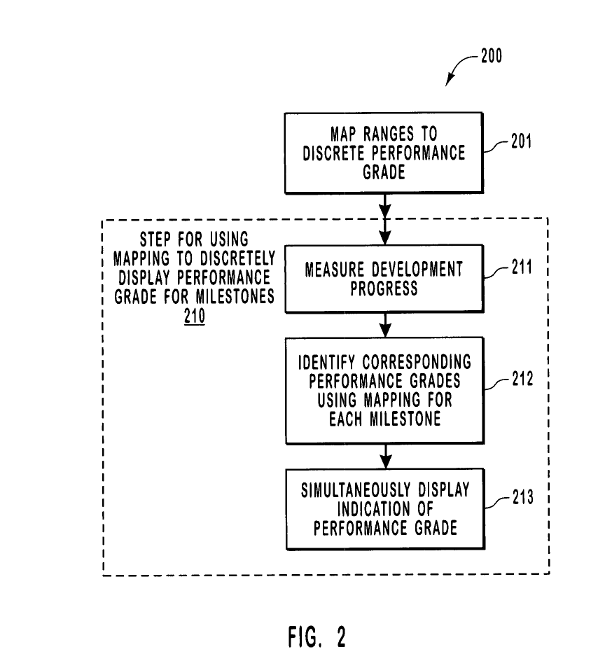

FIG. 2 illustrates a flowchart of a method 200 for the computing system to render product development progress on the display in a manner that allows development progress with respect to multiple development milestones to be simultaneously viewed. The computing system 200 that implements the method may be the same as the computer 120 described above with respect to FIG. 1, although that need not be the case by any means. In that case, however, the method may be implemented by having the processing unit 121 execute product development tracking software. The product development tracking software may be, for example, one of the application programs 136. The product which has its development being tracked may be a software product. However, the features of the present invention may also be used to track product development related to non-software products as well.

The method 200 includes an act of mapping each of a range of development progress levels to a corresponding discrete performance grade for each milestone related to the product development (act 201). In one embodiment, the development progress levels are not only mapped to a performance grade for each milestone, but also each of a number of different performance factors and development team as well.

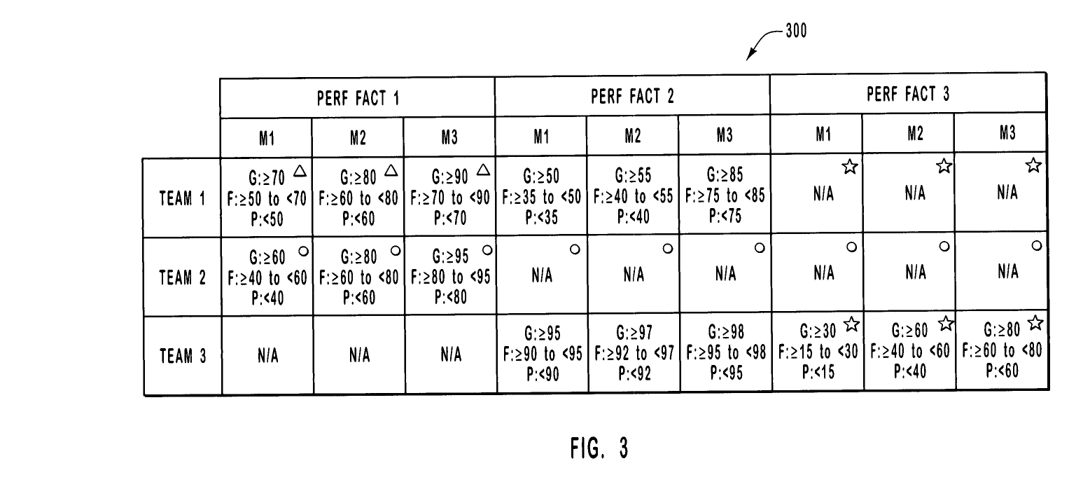

FIG. 3 includes a performance grade definition table 300 that may be maintained by the computing system in order to track performance grade mappings for each milestone, team, and performance factor. In the performance grade definition table, there are three performance factors labeled PERF FACT 1, PERF FACT 2, and PERF FACT 3. There are three milestones labeled M1, M2 and M3. Also, there are three teams labeled TEAM 1, TEAM 2 and TEAM 3.

In the example table, some performance factors are not relevant to particular teams. For example, performance factor 1 is not relevant to team 3, performance factor 2 is not relevant to team 2, and performance factor 3 is not relevant to teams 1 and 2.

For each of the other table entries, there is a specific mapping of device development progress levels to performance grades for each performance grade. For example, for team 1, performance factor 1 and milestone 3, development progress measuring equal to or greater than 90 maps to a good performance grade represented by “G”. Development progress measuring greater than or equal to 70, yet less than 90, maps to a fair performance grade represented by “F”. Development progress measuring less than 70 maps to a poor performance grade represented by “P”. Note that the mapping may be different for each table entry as illustrated. Although the performance grade definition table 300 is illustrated as a table, any mechanism for mapping development progress levels to performance grades will suffice so long as the mapping may be interpreted by the computing system performing the method 200.

The performance factors are generically labeled as PERF FACT 1, PERF FACT 2 and PERF FACT 3 to demonstrate the general application of the principles of the invention to the tracking of development progress for any product. The identity of the performance factors may be set depending on the nature of the product itself. For example, for software products, performance factors may include stress/reliability metrics, number of bugs, percent completion of technical specifications, percentage of code completed, percentage of resources allocated, conformity with standards, and the like. For the development of automobiles, different performance factors would naturally be appropriate. Although three performance factors are represented in the performance grade definition table 300, more or less than three performance factors may be tracked. In addition, each performance grade may itself be the result from two or more other performance factors.

Also, although three milestones, M1, M2 and M3, are represented in FIG. 3, product development may involve any number of milestones, with the final milestone typically being the release of the product to the public.

Furthermore, although three teams are represented in FIG. 3, the number and identity of the teams will vary depending on the product being developed and on the preferences of those organizing the various teams.

The identity and number of performance factors, teams, and milestones, may be inputted by a user or may be set automatically with default values. The performance grade mappings themselves may also be inputted by a user. Even representatives of a team or a manager may be able to set mappings for a particular team subject to security policies.

The method then includes a functional, result-oriented step for using the mapping to discretely display the performance grade for at least some of the plurality of milestones at a particular point in time (step 210). This step may include any corresponding acts for accomplishing the step. However, in the illustrated embodiment, the step 210 includes corresponding acts 211, 212 and 213.

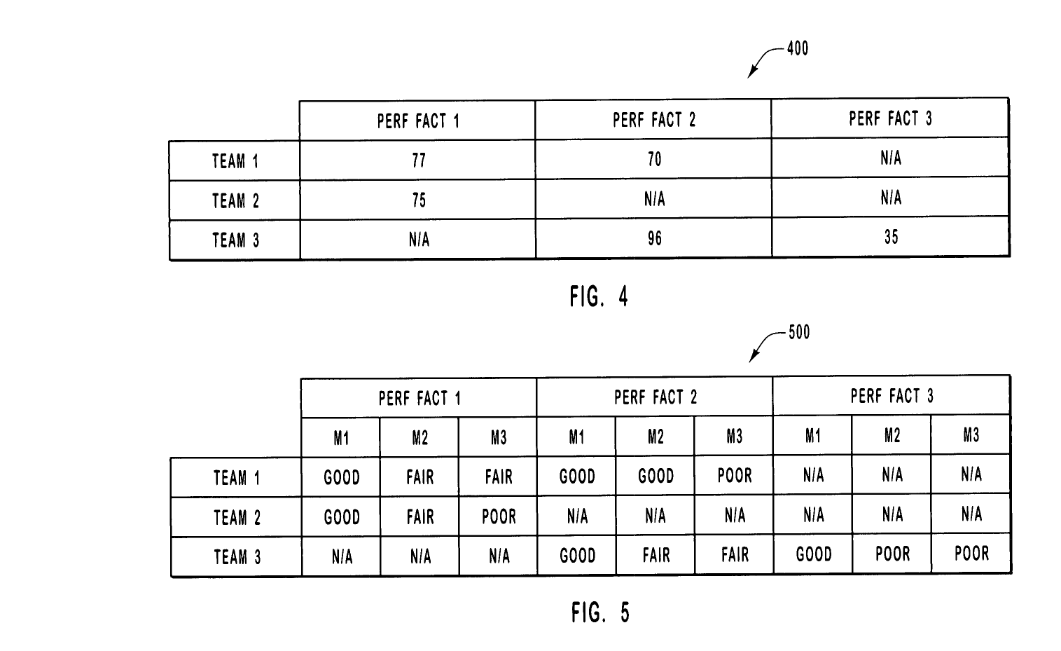

Specifically, the computing system measures the development progress at a particular point in time that occurs prior to multiple milestones (act 211). For example, the point in time may be prior to the arrival of milestone M1, in which case, milestones M1, M2 and M3 are yet to occur. Alternatively, the point in time may be after the arrival of milestone M1, but before the arrival of milestone M2, in which case, milestones M2 and M3 are yet to occur. FIG. 4 illustrates a measurement table 400 in which various performance levels are measured for each performance factor and for each team.

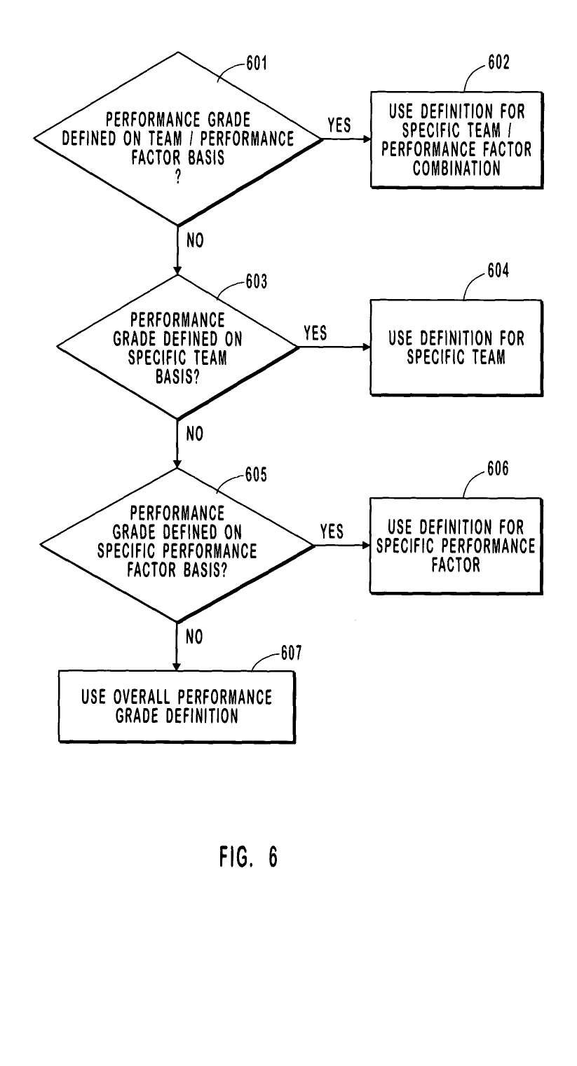

For at least some (and preferably all) of the milestones yet to occur, the computing system identifies a discrete performance grade that corresponds to the measured development progress using the performance grade mapping and the performance measurements (act 212). FIG. 5 illustrates a performance grade table 500 in which the resulting performance grade mapping is recorded for each team, milestone, and performance factor. For example, for team 1, performance factor 1 and milestone 3, the measured performance of 77 resides in the “FAIR” region defined by the performance grade definition table.

Now that a performance rating is gathered for each milestone, team, and performance rating, indications of the identified performance grade may be displayed for multiple milestones (act 213). For example, if the computing system implementing method 200 was the computing system 120 of FIG. 1, the computing system 120 may cause indications of performance grades for multiple milestones to be displayed using video adapter 148 and monitor 147. The visual indication of the performance grade may be displayed for each milestone, team, and performance factor. The visual indication may be a human-readable form of the indication. For example, the table 500 may actually be displayed in which “GOOD”, “FAIR”, and “POOR” are properly placed in the table to give the user a proper overall view of the health of the product development. Likewise, color (e.g., green for good, yellow for fair, and red for poor) may be displayed in their proper location to give this overall view.

Accordingly, at a single glance, the user may have a view of how everything is going generally. If a team is behind schedule on a particular performance factor, the user is readily apprised of that. Even if a team is ahead of schedule for a particular performance factor and milestones, but problems may arise for future milestones, the user is also apprised of the potential problem. For example, consider the table entries in table 500 for team 1 and performance factor 2. The performance grade is actually “GOOD” for the first and second milestones. However, the performance grade is “POOR” for the third milestone. Accordingly, a manager may take corrective action to be sure that everything is in place to meet the third milestone, instead of being lulled into a false sense of security by the positive report on the earlier milestones. The manager is thus more likely to institute corrections earlier, thereby more likely resulting in a successful and timely release of the product.

The performance definition table 300 of FIG. 3 is just one example of how the various performance grades may be defined. In another embodiment, the performance grade definitions may be obtained using a variety of different functions that together may be used to obtain a performance definition for a given team, performance factor and milestone. FIG. 6 illustrates a flowchart of a method 600 for obtaining a performance definition in accordance with another example. In describing FIG. 6, the performance definition table 300 of FIG. 3 will be frequently referred to to show that the method 600 may be used to obtain similar performance definitions as are shown for the performance definition table 300.

Referring to FIG. 6, it is determined whether or not there are any specific performance grade definitions defined on the basis of a combination of a specific team, and a specific performance factor (decision block 601). For example, suppose someone has chosen to define a performance grade that is applicable to the combination of team 1 and performance factor 1. That performance definition would take precedence over every other way of defining a performance grade, and the definition for the specific team/performance factor combination would be used to set the performance grade definition (act 602) for that a specific team/performance factor combination. At this point, referring to FIG. 3, the three fields labeled with a triangle in the upper right comer of each field could be populated.

For those team/performance factor combinations that did not have a performance grade definition on the basis of the combination of the team and performance factor (NO in decision block 601), it would then be determined whether or not there are any specific performance grade definitions defined on the basis of the specific team (decision block 603). For example, suppose someone has chosen to define a performance grade that is applicable to team 2 across all performance factors and milestones. That performance grade definition would take the next precedence, and the definition for the specific team would be used to set the performance grade definition (act 604) for that specific team across all performance factors and milestones. The exception would be that the team-based definition would not replace performance grade definitions defined for a specific team/performance factor. At this point, referring to FIG. 3, the nine fields labeled with a circle in the upper right comer of each field could be populated.

For those team/performance factor combinations that did not have a performance grade definition on the basis of the combination of the team and performance factor (NO in decision block 601), or on the basis of a specific team (NO in decision block 603), it would then be determined whether or not there are any specific performance grade definitions defined on the basis of the specific performance factor (decision block 605). For example, suppose someone has chosen to define a performance grade that is applicable to performance factor 3 across all teams and milestones. That performance grade definition would take third precedence, and the definition for the specific performance factor would be used to set the performance grade definition (act 606) for that specific performance factor across all teams and milestones. The exception would be that the performance factor-based definition would not replace performance grade definitions defined for a specific team/performance factor combination or for a specific team. At this point, referring to FIG. 3, the six fields labeled with a star in the upper right comer of each field could be populated.

For any remaining team/performance factor combinations, the performance grade definition may be obtained based on a fall-back value (act 607), which may be a performance grade that is set but not on the basis of a specific team, performance factor, or team/performance factor combination. For example, such performance grade definitions are represented in FIG. 3 by the nine fields that are not represented by a triangle, circle, or star, in their upper right corner.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes, which come within the meaning and range of equivalency of the claims, are to be embraced within their scope.

1. In a computing system that includes a display, a method for the computing system to render product development progress on the display in a manner that allows development progress with respect to multiple development milestones to be simultaneously viewed, the method comprising the following:
for each of a plurality of milestones, an act of mapping each of a range of development progress levels to a corresponding discrete performance grade;
an act of measuring the development progress at a particular point in time that occurs prior to a first subsequent milestone that occurs prior to a second subsequent milestone, each of the first and second subsequent milestones each being one of the plurality of milestones;
for each of the first and second subsequent milestones, an act of identifying a discrete performance grade that corresponds to the measured development progress using the mapping of the range of development progress levels within which the measured development progress resides to the corresponding identified performance grade; and
an act of simultaneously displaying an indication of the identified performance grade for the first subsequent milestone and an indication of the identified performance grade for the second subsequent milestone, wherein the manner of display differs depends on the identified performance grade.

2. A method in accordance with claim 1, wherein the performance grades are human-readable, the act of simultaneously displaying comprising the following:
an act of simultaneously displaying the identified human-readable performance grade for the first subsequent milestone and the identified human-readable performance grade for the second subsequent milestone.

3. A method in accordance with claim 1, wherein a different color corresponds to each of the plurality of performance grades, the act of simultaneously displaying comprising the following:
an act of simultaneously displaying the identified performance grade for the first subsequent milestone using a corresponding color and the identified performance grade for the second sequent milestone using a corresponding color.

4. A method in accordance with claim 1, the act of measuring the development progress at a particular point in time comprising the following:
an act of measuring each of a plurality of performance factors at the particular point in time, each of the performance factors being relevant to the development progress; and
an act of calculating the measured development progress using the measured performance factors as input.

5. A method in accordance with claim 1, wherein a plurality of performance factors are relate to product development, the measured development progress related to one of the performance factors, wherein the act of identifying a discrete performance grade and simultaneously displaying are performed for each of the plurality of performance factors.

6. A method in accordance with claim 1, wherein the development progress levels relate to the development of software.

7. A method in accordance with claim 1, wherein the development progress levels relate to products other than software.

8. A method in accordance with claim 1, wherein one or more milestones of the plurality of milestones occur between the particular point in time and the first subsequent milestone.

9. A method in accordance with claim 1, wherein the second subsequent milestone is a final milestone.

10. A method in accordance with claim 1, wherein no milestones occur between the particular point in time and the first subsequent milestone.

11. A method in accordance with claim 1, wherein one or more milestones of the plurality of milestones occur between the first subsequent milestone and the second subsequent milestone.

12. A method in accordance with claim 1, whereon no milestones occur between the first subsequent milestone and the second subsequent milestone.

13. A method in accordance with Claim l, wherein a third subsequent milestone occurs after the second subsequent milestone, the method further comprising the following:
for the third subsequent milestone, an act of identifying a discrete performance grade that corresponds to the measured development progress using the mapping of the range of development progress levels within which the measured development progress resides to the corresponding identified performance grade.

14. A method in accordance with claim 13, wherein the act of simultaneously displaying further comprises the following:
an act of simultaneously displaying an indication of the identified performance grade for the third subsequent milestone along with the indication of the identified performance grades for the first and second subsequent milestones.

15. A method in accordance with claim 1, wherein the method is performed for each of a plurality of teams.

16. A method in accordance with claim 15, wherein for one of the plurality of teams, the act of mapping each of a range of development progress levels to a corresponding discrete performance grade comprises the following:
an act of receiving user input from a representative of the team; and
an act of using the user input to at least partly determine the mapping.

17. A method in accordance with claim 1, wherein the act of mapping each of a range of development progress levels to a corresponding discrete performance grade comprises the following:
an act of receiving user input; and
an act of using the user input to at least partly determine the mapping.

18. In a computing system that includes a display, a method for the computing system to render product development progress on the display in a manner that allows development progress with respect to multiple development milestones to be simultaneously viewed, the method comprising the following:
for each of a plurality of milestones, an act of mapping each of a range of development progress levels to a corresponding discrete performance grade; and
a step for using the mapping to discretely display the performance grade for at least some of the plurality of milestones at particular point in time.

19. A method in accordance with claim 18, wherein the step for using the mapping to discretely display the performance grade for at least some of the plurality of milestones at particular point in time comprises the following corresponding acts:
an act of measuring the development progress at a particular point in time that occurs prior to a first subsequent milestone that occurs prior to a second subsequent milestone, each of the first and second subsequent milestones being one of the plurality of milestones;
for each of the first and second subsequent milestones, an act of identifying a discrete performance grade that corresponds to the measured development progress using the mapping of the range of development progress levels within which the measured development progress resides to the corresponding identified performance grade; and
an act of simultaneously displaying an indication of the identified performance grade for the first subsequent milestone and an indication of the identified performance grade for the second subsequent milestone, wherein the manner of display differs depending on the identified performance grade.

20. A computer program product for use in a computing system that includes a display and one or more processors, the computer program product for implementing a method for the computing system to render product development progress on the display in a manner that allows development progress with respect to multiple development milestones to be simultaneously viewed, the computer program product comprising one or more computer-readable media having thereon computer-executable instructions that, when executed by the one or more processors, cause the computing system to perform the following:
for each of a plurality of milestones, an act of mapping each of a range of development progress levels to a corresponding discrete performance grade;
an act of measuring the development progress at a particular point in time that occurs prior to a first subsequent milestone that occurs prior to a second subsequent milestone, each of the first and second subsequent milestones being one of the plurality of milestones;
for each of the first and second subsequent milestones, an act of identifying a discrete performance grade that corresponds to the measured development progress using the mapping of the range of development progress levels within which the measured development progress resides to the corresponding identified performance grade; and
an act of simultaneously displaying an indication of the identified performance grade for the first subsequent milestone and an indication of the identified performance grade for the second subsequent milestone, wherein the manner of display differs depending on the identified performance grade.

21. A computer program product in accordance with claim 20, wherein the computer-executable instructions for performing the act of measuring the development progress at a particular point in time comprise computer-executable instructions that, when executed by the one of more processors, cause the computing system to perform the following:
an act of measuring each of a plurality of performance factors at the particular point in time, each of the performance factors being relevant to the development progress; and
an act of calculating the measured development progress using the measured performance factors as input.

22. A computer program product in accordance with claim 20, wherein a third subsequent milestone occurs after the second subsequent milestone, the one or more computer-readable media further having thereon computer-executable instructions that, when executed by the one or more processors, cause the computing system to perform the following:
for the third subsequent milestone, an act of identifying a discrete performance grade that corresponds to the measured development progress using the mapping of the range of development progress levels within which the measured development progress resides to the corresponding identified performance grade.

23. A computer program product in accordance with claim 22, wherein the computer-executable instructions for simultaneously displaying further comprise computer-executable instructions that, when executed by the one or more processors, cause the computing system to perform the following:
an act of simultaneously displaying an indication of the identified performance grade for the third subsequent milestone along with an indication of the identified performance grades for the first and second subsequent milestones.

24. A computer program product in accordance with claim 20, wherein the computer-executable instructions for performing the act of mapping each of a range of development progress levels to a corresponding discrete performance grade comprise computer-executable instructions that, when executed by the one or more processors, cause the computing system to perform the following:
an act of receiving user input; and
an act of using the user input to at least partly determine the mapping.

25. A computer program product in accordance with claim 20, wherein the one or more computer-readable media comprise physical memory media.

26. A computer-readable media having thereon the following:
a first data field representing for each of a plurality of milestones mapping of each of a range of development progress levels to a corresponding discrete performance grade;
a second data field representing a measured development progress at a particular point in time; and
a third data field representing an identified performance grade for each of the plurality of milestones for the measured development progress of the second field using the mapping represented in the first data field.

27. A computer-readable media in accordance with claim 26, wherein
the first data field represents the mapping of each of a range of development progress levels to a corresponding discrete performance grade for each of the plurality of milestones and for each of a plurality of teams; and
the third data field represents an identified performance grade for each of the plurality of milestone and for each of the plurality of teams for the measure development progress of the second field using the mapping represented in the first data field.

28. A computer-readable media in accordance with claim 26, wherein
the first data field represents the mapping of each of a range of development progress levels to a corresponding discrete performance grade for each of the plurality of milestones, for each of a plurality of teams, and for each of a plurality of factors relevant to product development; and
the third data field represents an identified performance grade for the measure development progress of the second field using the mapping represented in the first data field for each of the plurality of milestones, for each of a plurality of teams, and for each of a plurality of factors relevant to product development.

29. A computer-readable media in accordance with claim 26, wherein
the first data field represents the mapping of each of a range of development progress levels to a corresponding discrete performance grade for each of the plurality of milestones and for each of a plurality of factors relevant to product development; and
the third data field represents an identified performance grade for the measure development progress of the second field using the mapping represented in the first data field for each of the plurality of milestones and for each of a plurality of factors relevant to product development.

30. A computer program product in accordance with claim 26, wherein the computer-readable media comprises physical memory media.
